(19) United States
(12) Patent Application Publication
(10) Pub. No.: US 2016/0111019 A1
(43) Pub. Date: Apr. 21, 2016

(54) METHOD AND SYSTEM FOR PROVIDING FEEDBACK OF AN AUDIO CONVERSATION

(71) Applicant: Kast Inc., San Diego, CA (US)

(72) Inventors: Yuja Chang, San Diego, CA (US); Suman Kanuganti, San Diego, CA (US); Robin Bisarya, San Diego, CA (US)

(21) Appl. No.: 14/514,533

(22) Filed: Oct. 15, 2014

(51) Int. Cl. G09B 19/04

(52) U.S. Cl. CPC G09B 19/04

(57) ABSTRACT

The present disclosure provides a method and system for providing a feedback of analysis of a plurality of pre-defined attributes of an audio conversation to a user. The user wears an interactive wearable device. The method and system includes enabling selection of a pre-defined profile from a plurality of pre-defined profiles of the interactive wearable device, extracting values of the plurality of pre-defined attributes of the audio conversation corresponding to the selected pre-defined profile, transmitting the plurality of pre-defined attributes of the audio conversation and receiving the feedback corresponding to the audio conversation. The received feedback is based on processing of the pre-determined values of the plurality of pre-defined attributes of the audio conversation with respect to a pre-determined value of each of a corresponding plurality of pre-defined attributes for the selected pre-defined profile of the interactive wearable device.

### TECHNICAL FIELD

The present invention relates to the field of feedback of audio conversations and, in particular, relates to feedback of an audio conversation by utilizing interactive wearable devices.

### BACKGROUND

In today's fast paced life, success of endeavor hinges on the ability to communicate effectively. Communication skills of an individual is tested everywhere, for example, during an interview, or during a presentation to business clients, project leader and board of directors, or writing a report and the like. An engineer giving his/her thesis presentation would require different skills from a business leader who has to present the roadmap of a company to their board of directors. Effective communication skills depend on a number of factors. The factors include but may not be limited to the usage of words, speed of delivery of words, pitch modulation, body language, tone, accent and one or more external factors.

Using the right tools to communicate the right messages at the right time can salvage crises and motivate people to work hard towards success. There are many institutions that have courses teaching effective communications for leaders. For example, a few of the top notch instructors delivers communication lessons either online or via CD/DVDs. Further, there are several books/e-books for advanced communication skills. In addition, there are communication courses available at universities and institutions. Although, these systems/sources of understanding the art of effective communication provide some feedback mechanism but it last only till the time of the course. However, it is a known fact that the communication only gets better with continuous feedback and with continuous monitoring. For busy people, it's often very time consuming to record their conversations, heard by an expert to provide advice and iterate on their mistakes. None of the existing alternatives provides a real time feedback mechanism to the users for improving their communication on regular basis. Also, even if the instructor provides the feedback to recorded speech of an individual at a later stage, the feedback may not be accurate as the instructor may not be able to accurately imagine the circumstances/environment in which the speech is delivered.

In light of the above stated discussion, there is a need for a method and system that overcomes the above stated disadvantages. Further, the method and system provide real-time feedback for improving communication skills.

### SUMMARY

In an aspect of the present disclosure, a method for providing a feedback of analysis of a plurality of pre-defined attributes of an audio conversation to a user is provided. The user wears an interactive wearable device. The method includes enabling selection of a pre-defined profile from a plurality of pre-defined profiles of the interactive wearable device, extracting values of the plurality of pre-defined attributes of the audio conversation corresponding to the selected pre-defined profile, transmitting the values of the plurality of pre-defined attributes of the audio conversation and receiving the feedback corresponding to the audio conversation. The received feedback is based on processing of the values of the plurality of pre-defined attributes of the audio conversation with respect to a pre-determined value of each of the corresponding plurality of pre-defined attributes for the selected pre-defined profile of the interactive wearable device.

In an embodiment of the present disclosure, the method includes activating the interactive wearable device worn by the user. In an embodiment of the present disclosure, the processing is based on matching of the values of the plurality of pre-defined attributes of the audio conversation with the pre-determined value of each of the corresponding plurality of pre-defined attributes for the selected pre-defined profile. The received feedback includes providing at least one of alerting vibrations and a pre-determined set of reports.

In an embodiment of the present disclosure, the alerting vibrations are produced when the corresponding value for each of the corresponding plurality of pre-defined attributes for the selected pre-defined profile exceeds beyond a corresponding threshold mark. In another embodiment of the present disclosure, the pre-determined set of reports is generated by utilizing a pre-defined set of scoring steps. The pre-defined set of scoring steps is measured against a baseline using one or more pre-configured profiles.

In an embodiment of the present disclosure, the plurality of pre-defined attributes includes a first set of pre-defined attributes based on technical attributes associated with the user, a second set of pre-defined attributes based on a plurality of bio-markers associated with the user, a third set of pre-defined attributes based on responses to interaction of the audio conversation with other one or more users and a fourth set of pre-defined attributes based on physical attributes associated with the user. The first set of pre-defined attributes includes at least one of tone, accent, pitch level, language, vocal energy and grammar. The second set of pre-defined attributes includes at least one of stress, body temperature, deep breaths, and heart beat rate. The fourth set of pre-defined attributes includes at least one of hand gestures and facial expressions.

In another aspect of the present disclosure, a method for providing a feedback of analysis of a plurality of pre-defined attributes of an activity performed by a user is provided. The user wears an interactive wearable device. The method includes receiving a selected pre-defined profile from a plurality of pre-defined profiles of the interactive wearable device, collecting the corresponding values for the plurality of pre-defined attributes of the activity corresponding to the selected pre-defined profile, processing the corresponding values for the plurality of pre-defined attributes of the activity with respect to a corresponding pre-determined value of each of the corresponding plurality of pre-defined attributes for the selected pre-defined profile and transmitting the feedback corresponding to the activity based on the processing.

In an embodiment of the present disclosure, the method includes storing the corresponding values for the plurality of pre-defined attributes of the activity of the user, the pre-defined profile corresponding to the user and the plurality of pre-defined profiles.

In an embodiment of the present disclosure, the collected plurality of pre-defined attributes includes a first set of pre-defined attributes based on technical attributes associated with the user, a second set of pre-defined attributes based on a plurality of bio-markers associated with the user, a third set of pre-defined attributes based on responses to interaction of the activity with the other one or more users and a fourth set of pre-defined attributes based on physical attributes associated with the user. The first set of pre-defined attributes includes at least one of tone, accent, pitch level, language, vocal energy, and grammar. The second set of pre-defined attributes includes at least one of stress, body temperature, deep breaths, and heart beat rate. The fourth set of pre-defined attributes includes at least one of hand gestures and facial expressions.

In an embodiment of the present disclosure, the processing is based on matching of the corresponding values for the plurality of pre-defined attributes of the activity with the pre-determined value of each of the corresponding plurality of pre-defined attributes for the selected pre-defined profile.

In an embodiment of the present disclosure, the feedback includes providing at least one of alerting vibrations and a pre-determined set of reports. The alerting vibrations are produced on exceeding the corresponding value of each of the corresponding plurality of pre-defined attributes for the selected pre-defined profile beyond a corresponding threshold mark.

In an embodiment of the present disclosure, the pre-determined set of reports is generated utilizing a pre-defined set of scoring steps. The pre-defined set of scoring steps is measured against a baseline using one or more pre-configured profiles. In an embodiment of the present disclosure, the activity includes at least one of an audio conversation, hand movements of the user and facial gestures of the user.

In yet another aspect of the present disclosure, a system for analysis of a plurality of pre-defined attributes of an audio conversation to a user is provided. The system includes an interactive wearable device worn by the user and an application server. The interactive wearable device includes a microphone configured to fetch corresponding values of plurality of pre-defined attributes of the audio conversation of the user, a plurality of sensors configured to fetch a second set of pre-defined attributes and a fourth set of pre-defined attributes from the plurality of pre-defined attributes associated with the user and a data transmission chip configured to transmit the corresponding values of the plurality of pre-defined attributes of the audio conversation. The plurality of pre-defined attributes is associated with a selected profile of a plurality of pre-defined profiles. The second set of pre-defined attributes is based on a plurality of bio-markers including at least one of stress, body temperature, deep breaths, and heart beat rate. The fourth set of pre-defined attributes is based on physical attributes associated with the user including at least one of hand gestures and facial expressions. The application server includes a processing module to process the corresponding values of the plurality of pre-defined attributes of the audio conversation corresponding to the pre-defined profile of the user and a feedback module configured to transmit a real time feedback to the user.

In an embodiment of the present disclosure, the application server includes a selection module to select the pre-defined profile from the plurality of pre-defined profiles, a receiving module configured to receive the selected pre-defined profile from the plurality of pre-defined profiles by the interactive wearable device and the corresponding values of plurality of pre-defined attributes of the audio conversation corresponding to the selected pre-defined profile, and a database configured to store the corresponding values for the plurality of pre-defined attributes of the audio conversation of the user, the pre-defined profile corresponding to the user and the plurality of pre-defined profiles.

In an embodiment of the present disclosure, the application server includes an activation module to activate the interactive wearable device worn by the user. In an embodiment of the present disclosure, the processing is based on matching of the corresponding values of the plurality of pre-defined attributes of the audio conversation with the pre-determined value of each of the corresponding plurality of pre-defined attributes for the selected pre-defined profile.

In an embodiment of the present disclosure, the feedback includes providing alerting vibrations and a pre-determined set of reports. The alerting vibrations are produced on exceeding the pre-determined value of each of the corresponding plurality of pre-defined attributes for the selected pre-defined profile beyond a threshold mark.

In yet another embodiment of the present disclosure, the pre-determined set of reports is generated utilizing a pre-defined set of scoring steps. The pre-defined set of scoring steps is measured against a baseline using one or more pre-configured profiles.

### BRIEF DESCRIPTION OF THE FIGURES

Having thus described the invention in general terms, reference will now be made to the accompanying drawings, which are not necessarily drawn to scale, and wherein:

FIG. 1 illustrates a system for providing feedback of analysis of a plurality of pre-defined attributes of an activity performed by a user, in accordance with various embodiments of the present disclosure;

FIG. 2 illustrates a flowchart for providing the feedback of the activity to the user, in accordance with various embodiments of the present disclosure;

FIG. 3 illustrates an interaction between the interactive wearable device and the application server, in accordance with the various embodiments of the present disclosure; and

FIG. 4 illustrates a flowchart for processing the corresponding pre-determined values of the plurality of pre-defined attributes, in accordance with various embodiments of the present disclosure.

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

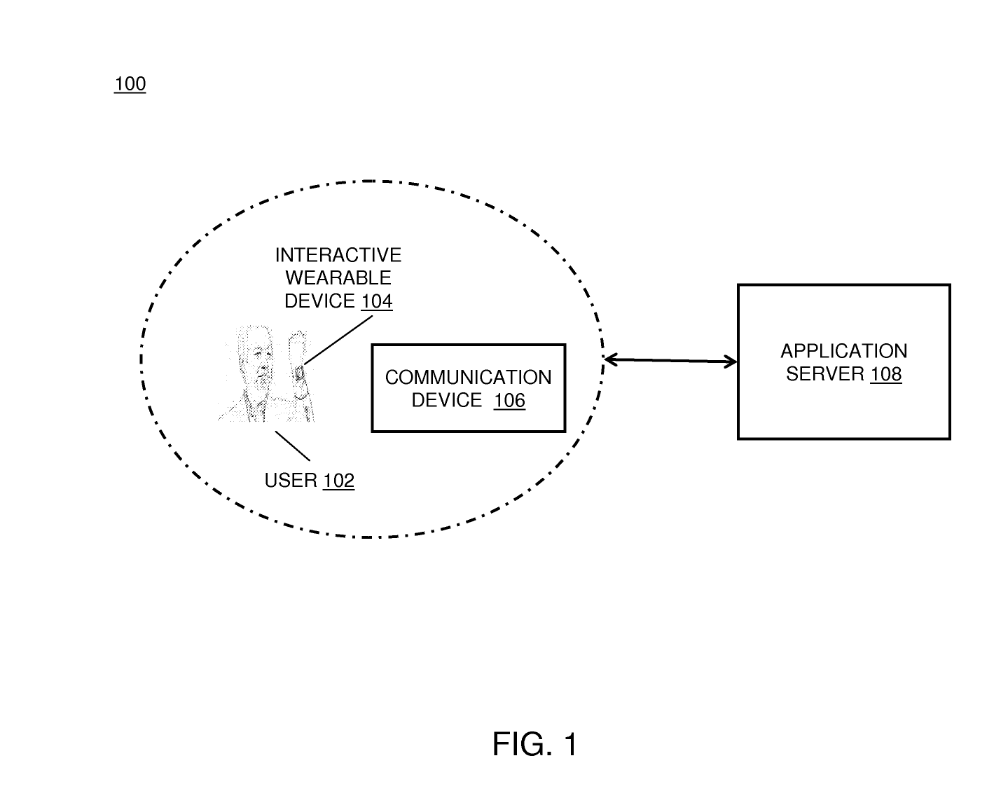

FIG. 1 illustrates a system 100 for providing feedback of an activity, in accordance with various embodiments of the present disclosure. The system 100 includes a user 102 wearing an interactive wearable device 104. Examples of the interactive wearable device 104 include but not limited to digital eyeglasses, a wearable necklace, a Google glass, a wrist band, a smart watch or any other wearable device which can integrate a microphone, one or more sensors and have networking capabilities to transmit/receive data. The user 102 may be a professional giving a business presentation to his/her team leader, a speaker giving a public speech to a large audience who is in a routine of interacting frequently with one or more people. The user 102 is associated with a communication device 106. Examples of the communication device 106 include but may not be limited to mobile phones, tablets, or any other portable communication device. The user 102 activates the interactive wearable device 104 using the communication device 106.

In an embodiment of the present disclosure, the user 102 set a schedule to activate the interactive wearable device 104. In addition, the user 102 selects a pre-defined profile from a plurality of pre-defined profiles. The plurality of pre-defined profiles includes but may not be limited to a business meeting, a hallway conversation, a public speech and a classroom presentation. For example, a user X selects the business meeting profile and activates his/her interactive wearable device Y before the meeting starts to monitor his/her communication skills.

The interactive wearable device 104 extracts values of the plurality of pre-defined attributes of the activity corresponding to the selected pre-defined profile. The activity includes at least one of an audio conversation, hand movements of the user 102 and facial gestures of the user 102. Examples of the plurality of pre-defined attributes include tone, accent, pitch level, stress, body temperature and the like. The interactive wearable device 104 transmits the values of plurality of pre-defined attributes of the activity to an application server 108. The application server 108 processes the plurality of pre-defined attributes and provides a feedback to the user 102. In an embodiment of the present disclosure, the interactive wearable device 104 transmits the plurality of pre-defined attributes to the communication device 106.

The communication device 106 transmits the plurality of pre-defined attributes to the application server 108. Continuing with the above example, when the user X goes for the business meeting, the interactive wearable device Y extracts the attributes including his/her tone, stress and accent during the meeting and transmits these attributes to the application server 108. The application server 108 processes these attributes to provide feedback to the user X.

It may be noted that in FIG. 1, the communication device 106 activates the interactive wearable device 104; however those skilled in the art would appreciate that the interactive wearable device 104 may be activated automatically on its own. For example, the interactive wearable device Y may be activated using an in-built program/button. In addition, it may be noted that the application server 108 is shown to be interacting with the interactive wearable device 104; however, those skilled in the art would appreciate that the application server 108 interacts with the plurality of interactive wearable devices associated with corresponding different users.

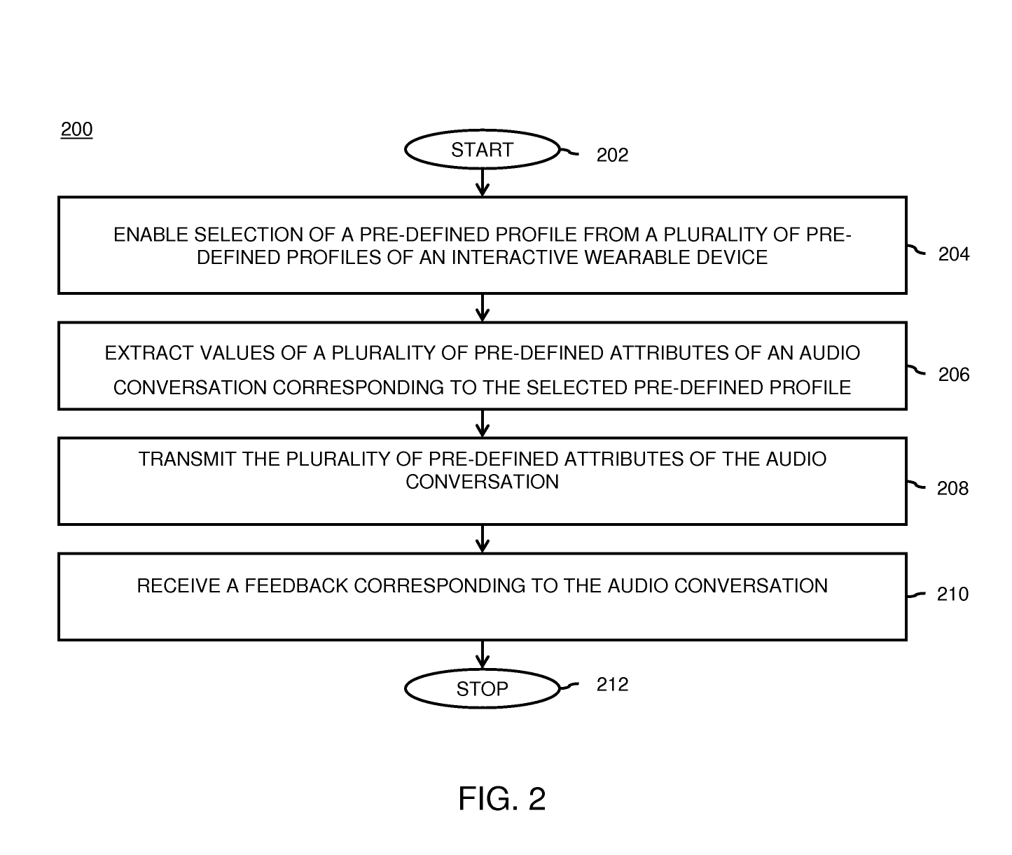

FIG. 2 illustrates a flowchart 200 for providing the feedback of the activity performed by the user 102, in accordance with various embodiments of the present disclosure. It may be noted that to explain various process steps of the flowchart 200, references will be made to the various elements of the FIG. 1.

The flowchart 200 initiates at step 202. At step 204, the interactive wearable device 104 selects the pre-defined profile from the plurality of pre-defined profiles of the interactive wearable device 104. The plurality of pre-defined profiles includes the business meeting, the hallway conversation, the public speech, the classroom presentation and the like. For example, the user X selects the business meeting profile and activates his/her interactive wearable device Y before the meeting starts to monitor his/her communication skills. In an embodiment of the present disclosure, the user 102 may activate the interactive wearable device 104 and configure the pre-defined profile in early morning.

Following step 204, at step 206, the interactive wearable device 104 extracts the values of the plurality of pre-defined attributes of the activity corresponding to the selected pre-defined profile. The activity includes at least one of the audio conversation, hand movements of the user 102 and facial gestures of the user 102. The plurality of pre-defined attributes includes a first set of pre-defined attributes based on technical attributes associated with the user 102, a second set of pre-defined attributes based on a plurality of bio-markers associated with the user 102, a third set of pre-defined attributes based on responses to interaction of the activity with other one or more users and a fourth set of pre-defined attributes based on physical attributes associated with the user 102. The first set of pre-defined attributes includes tone, accent, pitch level, language, vocal energy, grammar and the like. The second set of pre-defined attributes includes stress, body temperature, deep breaths, heart beat rate, breath rate and the like. The fourth set of pre-defined attributes includes hand gestures, facial expressions and the like. For example, when the user X goes for the business meeting, the interactive wearable device Y extracts the attributes including his/her tone, stress, facial expressions and accent during the meeting. In addition, the interactive wearable device Y extracts the tone and accent of the one or more other users present in the meeting.

At step 208, the interactive wearable device 104 transmits the plurality of pre-defined attributes of the activity to the application server 108. The application server 108 processes the plurality of pre-defined attributes. In an embodiment of the present disclosure, the interactive wearable device 104 transmits the plurality of pre-defined attributes of the activity to the communication device 106. The communication device 106 transmits the plurality of pre-defined attributes of the activity to the application server 108. The processing is based on matching of the pre-determined values of the plurality of pre-defined attributes of the activity with a pre-determined value of each of the corresponding plurality of pre-defined attributes for the selected pre-defined profile. In an embodiment, an administrator decides the pre-determined values for each of the attributes. In an embodiment of the present disclosure, the term value of a corresponding attribute can be a range of the values set by the administrator or collected by application server 108.

At step 210, the interactive wearable device 104 receives the feedback corresponding to the activity performed by the user 102. The received feedback is based on the processing of the pre-determined values of the plurality of pre-defined attributes of the activity with respect to the pre-determined value of each of the corresponding plurality of pre-defined attributes for the selected pre-defined profile. The received feedback includes at least one of alerting vibrations and a pre-determined set of reports. The alerting vibrations are produced on exceeding the corresponding pre-determined value of each of the corresponding plurality of pre-defined attributes for the selected pre-defined profile beyond a corresponding threshold mark. The pre-determined set of reports is generated by utilizing a pre-defined set of scoring steps. The pre-defined set of scoring steps is measured against a baseline using one or more pre-configured profiles. In an embodiment of the present disclosure, the feedback can be provided real-time or by an online expert/agent or through artificial intelligence to the user 102 by utilizing the recorded values of the pre-defined attributes corresponding to pre-defined profiles, past records, consolidated records, his/her profile information including age, gender, jurisdiction, and the like and techniques for improvement of the communication skills. The online expert/agent has a marketplace ratings, pricings to review and schedules.

Extending the above example, the interactive wearable device Y transmits the attributes including the tone, stress, facial expressions and accent of the user X during the meeting and the tone and accent of the one or more other users present in the meeting to the application server 108. The application server 108 matches the tone, stress, facial expressions and accent of the user X during the meeting with stored values of the tone, stress, facial expressions and accent for the business meeting profile and generates the feedback. If the attributes (say tone and stress) of the user X in the meeting do not lie in appropriate range, then the user X receives the feedback (vibrations) with set of reports showing inappropriate results.

In an embodiment of the present disclosure, the user 102 configures the alerting messages. For example, the user X can set the vibration whenever his/her words per minute exceed normal perception levels or the user X can set the vibration when pitch radius is not enough for the radius intended thus providing intelligible ways to the user X for better communication in real time.

In an embodiment of the present disclosure, the system 100 includes activating the interactive wearable device 104 worn by the user 102. The user 102 activates the interactive wearable device 104 just before the meeting to monitor the communication skills. In another embodiment of the present disclosure, the user 102 may activate the interactive wearable device 104 in the early morning to monitor the communication skills for the entire day. The flowchart 200 terminates at step 210.

In an embodiment of the present disclosure, the user 102 may check his/her historical performance of communication with pre-defined metrics in his/her personalized dashboard.

It may be noted that the flowchart 200 is explained to have above stated process steps; however, those skilled in the art would appreciate that the flowchart 200 may have more/less number of process steps which may enable all the above stated embodiments of the present disclosure.

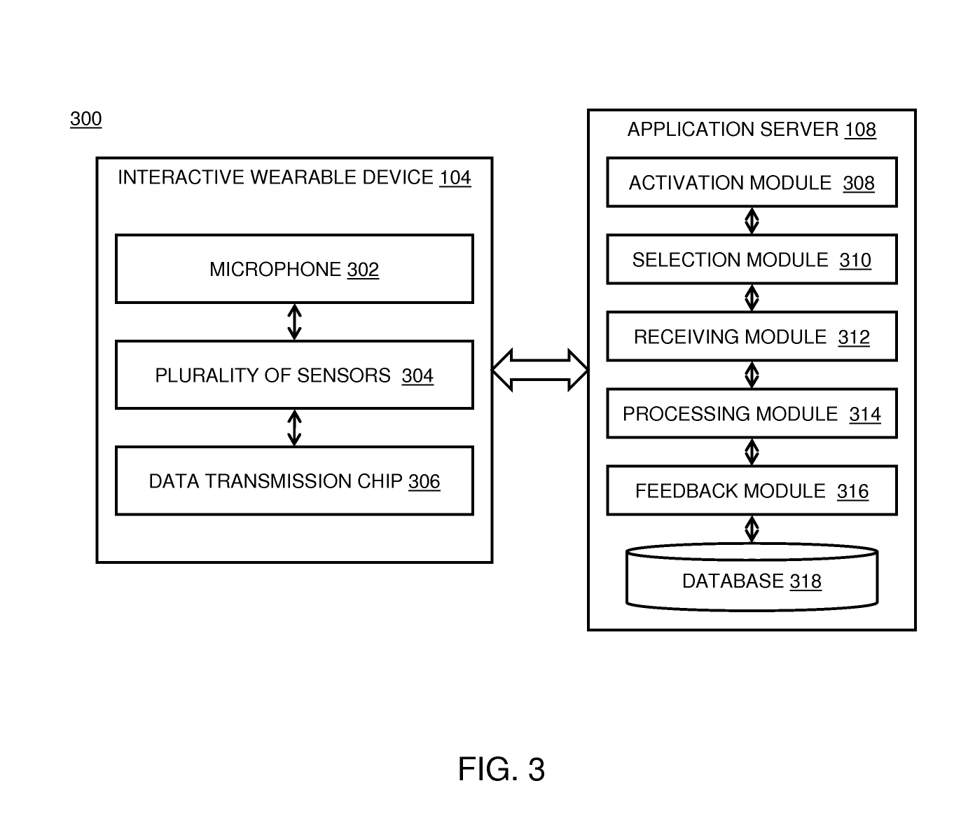

FIG. 3 illustrates interaction between the interactive wearable device 104 and the application server 108, in accordance with the various embodiments of the present disclosure. It may be noted that to explain FIG. 3, references will be made to the system elements of FIG. 1 and process steps of FIG. 2. The interactive wearable device 104 includes a microphone 302, a plurality of sensors 304 and a data transmission chip 306. The microphone 302 is an acoustic-to-electric transducer/sensor that convert sound in air into an electrical signal. In an embodiment of the present disclosure, the microphone 302 fetches the corresponding values of the plurality of pre-defined attributes of the activity of the user 102.

As mentioned above, the plurality of pre-defined attributes is associated with the selected profile of the plurality of profiles. The plurality of pre-defined attributes includes the first set of pre-defined attributes based on the technical attributes associated with the user 102, the second set of pre-defined attributes based on the plurality of bio-markers associated with the user 102, the third set of pre-defined attributes based on the responses to the interaction of the activity with the other one or more users and the fourth set of pre-defined attributes based on the physical attributes associated with the user 102. The first set of pre-defined attributes includes tone, accent, pitch level, language, vocal energy, grammar and the like. The second set of pre-defined attributes includes stress, body temperature, deep breaths, heart beat rate, breath rate and the like. The fourth set of pre-defined attributes includes hand gestures, facial expressions and the like. The plurality of sensors 304 fetches the second set of pre-defined attributes and the fourth set of pre-defined attributes from the plurality of pre-defined attributes associated with the user 102. The data transmission chip 306 may include but may not be limited to Bluetooth program or any other chip capable of transmitting data. The data transmission chip transmits the corresponding values of the plurality of pre-defined attributes of the activity. Continuing with the above example, the microphone 302 fetches the values of attributes like the tone, accent and pitch level of the activity of the user X during his/her business meeting and the sensors fetches the attributes like the stress, the body temperature, the deep breaths, the heart beat rate and the breath rate and the Bluetooth of the interactive wearable device Y transmits these attributes to the application server 108. The application server 108 processes the corresponding pre-determined values of the plurality of pre-defined attributes of the activity corresponding to the pre-defined profile of the user 102.

The application server 108 includes an activation module 308, a selection module 310, a receiving module 312, a processing module 314, a feedback module 316 and a database 318. The activation module 308 activates the interactive wearable device 104 worn by the user 102. The selection module 310 selects the pre-defined profile from the plurality of pre-defined profiles. The plurality of pre-defined attributes includes the first set of pre-defined attributes based on the technical attributes associated with the user 102, the second set of pre-defined attributes based on the plurality of bio-markers associated with the user 102, the third set of pre-defined attributes based on the responses to the interaction of the activity with the other one or more users and the fourth set of pre-defined attributes based on the physical attributes associated with the user 102. The first set of pre-defined attributes includes tone, accent, pitch level, language, vocal energy, grammar and the like. The second set of pre-defined attributes includes stress, body temperature, deep breaths, heart beat rate, breath rate and the like. The fourth set of pre-defined attributes includes hand gestures, facial expressions and the like.

The receiving module 312 receives the selected pre-defined profile from the plurality of pre-defined profiles by the interactive wearable device 104 and the corresponding values of the plurality of pre-defined attributes of the activity corresponding to the selected pre-defined profile. The processing module 314 processes the corresponding values of the plurality of pre-defined attributes of the activity corresponding to the pre-defined profile of the user 102. The processing is based on matching the corresponding pre-determined values of the plurality of pre-defined attributes of the activity with the pre-determined value of each of the corresponding plurality of pre-defined attributes for the selected pre-defined profile.

Going further, the feedback module 316 transmits a feedback to the user 102. The feedback includes at least one of the alerting vibrations and the pre-determined set of reports. The alerting vibrations are produced on exceeding the corresponding pre-determined value of each of the corresponding plurality of pre-defined attributes for the selected pre-defined profile beyond the corresponding threshold mark. The pre-determined set of reports is generated utilizing the pre-defined set of scoring steps. The pre-defined set of scoring steps is measured against a baseline using the one or more pre-configured profiles. The feedback can be provided real-time or by the online expert/agent or through artificial intelligence to the user 102 by utilizing the recorded values of the pre-defined attributes corresponding to pre-defined profiles, past records, consolidated records, his/her profile information including age, gender, jurisdiction, and the like and techniques for improvement of the communication skills (as illustrated in detailed description of FIG. 2). The online expert/agent has a marketplace ratings, pricings to review and schedules.

In an embodiment of the present disclosure, the feedback module 316 generates the feedback corresponding to the measured heart rate and the breath rate of the user 102. The pre-determined set of reports includes level of anxiousness of the user 102 and the techniques for controlling emotions and the anxiousness of the user 102.

In another embodiment of the present disclosure, the interactive wearable device 104 may include a wrist band, a smart watch or any other wearable device worn by the user 102 on wrist. The plurality of sensors 304 of the interactive wearable device 104 (the wrist band and the smart watch) captures the hand gestures of the user 102. The pre-determined set of reports provides the feedback for body language of the user 102 corresponding to the selected profile and associated techniques for delivery of non-verbal representation of speech.

In yet another embodiment of the present disclosure, the interactive wearable device 104 may include a contact lens. The plurality of sensors 304 of the interactive wearable device 104 (the contact lens) tracks eye contact of the user 102. The pre-determined set of reports provides the associated techniques for effective face to face conversations.

In yet another embodiment of the present disclosure, an in-built camera of the one or more other interactive wearable devices may detect the facial expressions of the user 102. For example, if the user X wearing the digital glass selects the public speaking profile, then the in-built camera of the digital glass detects the facial expressions of speaker (the user X) to correlate with his/her voice modulation and provides necessary feedback.

In yet another embodiment of the present disclosure, the interactive wearable device 104 integrates with the one or more other interactive wearable devices measuring the plurality of pre-defined attributes associated with the user 102.

The database 318 stores the corresponding pre-determined values of the plurality of pre-defined attributes of the activity of the user 102, the pre-defined profile corresponding to the user 102 and the plurality of pre-defined profiles.

In an embodiment of the present disclosure, the application server 108 maintains a profile of the interactive device 104 of the user 102. The profile may include the values of attributes from the plurality of pre-defined attributes corresponding to the selected profile of activity, past records, input of the user 102, and the like. The inputs of the user 102 can be a specific area of improvement, an area which he/she wants to ignore, and the like. This profile may be utilized for providing feedback to the user 102.

It may be noted that in FIG. 3, the interactive wearable device 104 transmits the fetched plurality of pre-defined attributes corresponding to the selected pre-defined profile of the activity of the user 102 to the application server 108; however, those skilled in the art would appreciate that the fetched plurality of pre-defined attributes corresponding to the selected pre-defined profile of the activity of more than one users can be transmitted to the application server 108. In addition, the application server 108 maintains the profile of one or more users. These respective profiles can be used for providing feedback to respective users for respective activity.

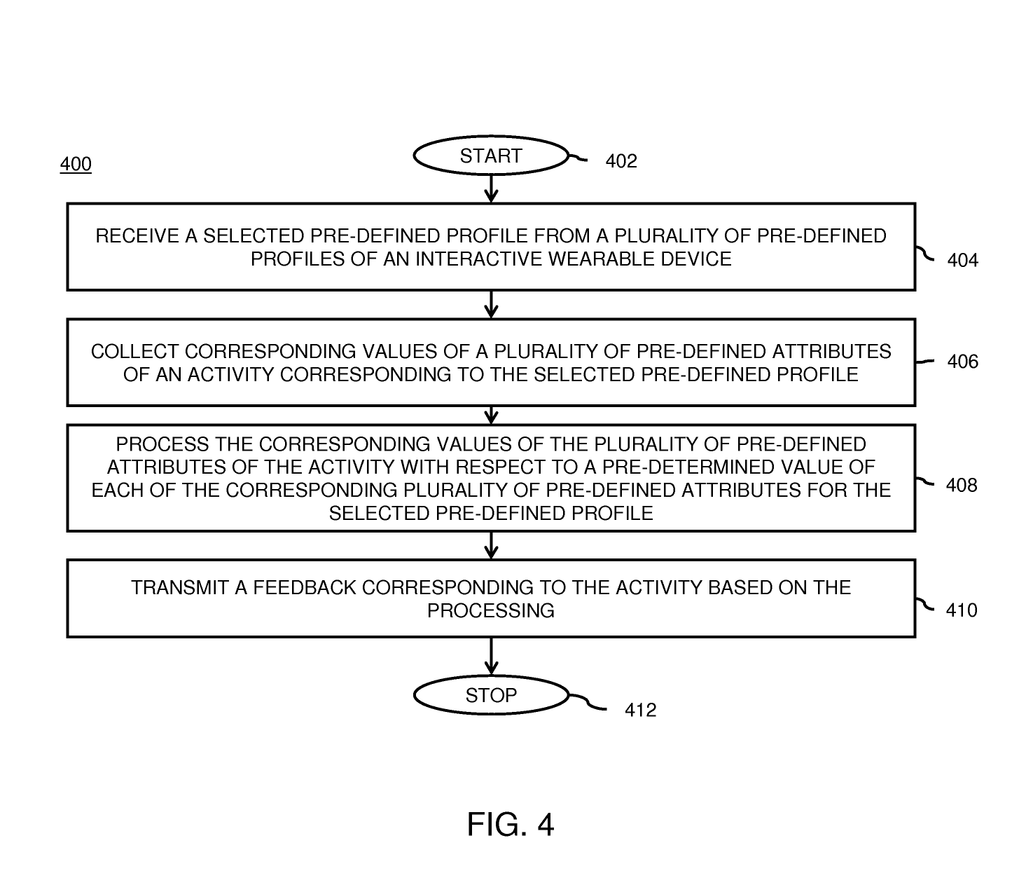

FIG. 4 illustrates a flowchart 400 for processing the corresponding pre-determined values of the plurality of pre-defined attributes corresponding to the activity performed by the user 102, in accordance with various embodiments of the present disclosure. It may be noted that to explain various process steps of the flowchart 400, references will be made to the various elements of the FIG. 1 and the FIG. 3 and various process steps of the flowchart 200 of the FIG. 2. The flowchart 400 initiates at step 402. Following step 402, at step 404, the application server 108 receives the selected pre-defined profile from the plurality of pre-defined profiles of the interactive wearable device 104. The plurality of pre-defined profiles includes but may not be limited to the business meeting, the hallway conversation, the public speech and the classroom presentation. At step 406, the application server 108 collects the corresponding pre-determined value of the plurality of pre-defined attributes of the activity corresponding to the selected pre-defined profile.

At step 408, the application server 108 processes the corresponding pre-determined values of the plurality of pre-defined attributes of the activity with respect to the corresponding pre-determined value of each of the corresponding plurality of pre-defined attributes for the selected pre-defined profile. The processing is based on matching of the corresponding pre-determined values of the plurality of pre-defined attributes of the activity with the pre-determined value of each of the corresponding plurality of pre-defined attributes for the selected pre-defined profile.

At step 410, the application server 108 transmits the feedback corresponding to the activity based on the processing. The feedback includes at least one of alerting vibrations and the pre-determined set of reports. The alerting vibrations are produced on exceeding the corresponding pre-determined value of each of the corresponding plurality of pre-defined attributes for the selected pre-defined profile beyond the corresponding threshold mark. The pre-determined set of reports is generated utilizing the pre-defined set of scoring steps. The pre-defined set of scoring steps is measured against a baseline using the one or more pre-configured profiles.

In an embodiment of the present disclosure, the application server 108 stores the corresponding pre-determined values of the plurality of pre-defined attributes of the activity of the user 102, the pre-defined profile corresponding to the user 102 and the plurality of pre-defined profiles.

In another embodiment of the present disclosure, the activity includes at least one of the audio conversation, hand movements of the user 102 and facial gestures of the user 102. The flowchart 400 terminates at step 412. It may be noted that the flowchart 400 is explained to have above stated process steps; however, those skilled in the art would appreciate that the flowchart 400 may have more/less number of process steps which may enable all the above stated embodiments of the present disclosure.

The above stated methods and system have many advantages. The above stated methods and system provides the real time feedback for improving communication skills of one or more users. In addition, the above stated methods and system provides continuous monitoring with real time feedback along with creating a new line of employment opportunities for communication experts to help users using technology as a medium.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A method for providing a feedback of analysis of a plurality of pre-defined attributes of an audio conversation to a user, said user wearing an interactive wearable device, said method comprising:
enabling selection of a pre-defined profile from a plurality of pre-defined profiles of said interactive wearable device;
extracting values of said plurality of pre-defined attributes of said audio conversation corresponding to said selected pre-defined profile;
transmitting said plurality of pre-defined attributes of said audio conversation; and
receiving said feedback corresponding to said audio conversation, wherein said received feedback being based on processing of said values of said plurality of pre-defined attributes of said audio conversation with respect to a pre-determined value of each of a corresponding said plurality of pre-defined attributes for said selected pre-defined profile of said interactive wearable device.

2. The method as recited in claim 1, further comprising activating said interactive wearable device worn by said user.

3. The method as recited in claim 1, wherein said processing being based on matching of said values of said plurality of pre-defined attributes of said audio conversation with said pre-determined value of each of corresponding said plurality of pre-defined attributes for said selected pre-defined profile.

4. The method as recited in claim 1, wherein said received feedback comprises providing at least one of alerting vibrations and a pre-determined set of reports, wherein said alerting vibrations being produced when said corresponding value for each of corresponding said plurality of pre-defined attributes for said selected pre-defined profile exceeds beyond a corresponding threshold mark.

5. The method as recited in claim 4, wherein said pre-determined set of reports being generated by utilizing a pre-defined set of scoring steps, and wherein said pre-defined set of scoring steps being measured against a baseline using one or more pre-configured profiles.

6. The method as recited in claim 4, wherein said feedback being received on real time basis.

7. The method as recited in claim 1, wherein said plurality of pre-defined attributes comprises
a. a first set of pre-defined attributes based on technical attributes associated with said user, wherein said technical attributes including at least one of tone, accent, pitch level, language, vocal energy and grammar;
b. a second set of pre-defined attributes based on a plurality of bio-markers associated with said user, wherein said plurality of bio-markers including at least one of stress, body temperature, deep breaths and heart beat rate;
c. a third set of pre-defined attributes based on responses to interaction of said audio conversation with other one or more users; and
d. a fourth set of pre-defined attributes based on physical attributes associated with said user.

8. A method for providing a feedback of analysis of a plurality of pre-defined attributes of an activity performed by a user, said user wearing an interactive wearable device, said method comprising:
receiving a selected pre-defined profile from a plurality of pre-defined profiles of said interactive wearable device;
collecting corresponding values for said plurality of pre-defined attributes of said activity corresponding to said selected pre-defined profile;
processing corresponding values of said plurality of pre-defined attributes of said activity with respect to a corresponding pre-determined value of each of corresponding said plurality of pre-defined attributes for said selected pre-defined profile; and
transmitting said feedback corresponding to said activity based on said processing.

9. The method as recited in claim 8, further comprising storing said corresponding values for said plurality of pre-defined attributes of said activity of said user, said pre-defined profile corresponding to said user and said plurality of pre-defined profiles.

10. The method as recited in claim 8, wherein said collected plurality of pre-defined attributes comprises:
a. a first set of pre-defined attributes based on technical attributes associated with said user, wherein said technical attributes including at least one of tone, accent, pitch level, language, vocal energy and grammar;
b. a second set of pre-defined attributes based on a plurality of bio-markers associated with said user, wherein said plurality of bio-markers including at least one of stress, body temperature, deep breaths and heart beat rate;
c. a third set of pre-defined attributes based on responses to interaction of said activity with other one or more users; and
d. a fourth set of pre-defined attributes based on physical attributes associated with said user.

11. The method as recited in claim 8, wherein said processing being based on matching of said corresponding values for said plurality of pre-defined attributes of said activity with said pre-determined value of each of corresponding said plurality of pre-defined attributes for said selected pre-defined profile.

12. The method as recited in claim 8, wherein said feedback comprises providing alerting vibrations and a pre-determined set of reports, wherein said alerting vibrations being produced on exceeding said corresponding value of each of corresponding said plurality of pre-defined attributes for said selected pre-defined profile beyond a corresponding threshold mark.

13. The method as recited in claim 12, wherein said pre-determined set of reports being generated utilizing a pre-defined set of scoring steps, and wherein said pre-defined set of scoring steps being measured against a baseline using one or more pre-configured profiles.

14. The method as recited in claim 8, wherein said activity being at least one of an audio conversation, hand movements of said user and facial gestures of said user.

15. A system of analysis of a plurality of pre-defined attributes of an audio conversation to a user, said user wearing an interactive wearable device, said system comprising:
an interactive wearable device worn by said user, wherein said interactive wearable device comprises:
a microphone configured to fetch corresponding values of said plurality of pre-defined attributes of said audio conversation of said user, wherein said plurality of pre-defined attributes being associated with a selected pre-defined profile of a plurality of pre-defined profiles;
a plurality of sensors configured to fetch a second set of pre-defined attributes and a fourth set of pre-defined attributes from said plurality of pre-defined attributes associated with said user, wherein said second set of pre-defined attributes being based on a plurality of bio-markers including at least one of stress, body temperature, deep breaths and heart beat rate and said fourth set of pre-defined attributes being based on physical attributes associated with said user including at least one of hand gestures and facial expressions; and
a data transmission chip configured to transmit said corresponding values of said plurality of pre-defined attributes of said audio conversation.
an application server, wherein said application server comprises
a processing module to process said corresponding values of said plurality of pre-defined attributes of said audio conversation corresponding to said pre-defined profile of said user; and
a feedback module configured to transmit a real time feedback to said user.

16. The system as recited in claim 15, wherein said application server further comprises:
a selection module to select said pre-defined profile from said plurality of pre-defined profiles;
a receiving module configured to receive
said selected pre-defined profile from said plurality of pre-defined profiles by said interactive wearable device;
said corresponding values of said plurality of pre-defined attributes of said audio conversation corresponding to said selected pre-defined profile; and
a database configured to store said corresponding values for said plurality of pre-defined attributes of said audio conversation of said user, said pre-defined profile corresponding to said user and said plurality of pre-defined profiles.

17. The system as recited in claim 15, wherein said application server further comprises an activation module to activate said interactive wearable device worn by said user.

18. The system as recited in claim 15, wherein said processing being based on matching of said corresponding values of said plurality of pre-defined attributes of said audio conversation with said pre-determined value of each of corresponding said plurality of pre-defined attributes for said selected pre-defined profile.

19. The system as recited in claim 15, wherein said feedback comprises providing alerting vibrations and a pre-determined set of reports, wherein said alerting vibrations being produced on exceeding said pre-determined value of each of corresponding said plurality of pre-defined attributes for said selected pre-defined profile beyond a threshold mark.

20. The system as recited in claim 15, said wherein said pre-determined set of reports being generated utilizing a pre-defined set of scoring steps, wherein said pre-defined set of scoring steps being measured against a baseline using one or more pre-configured profiles.
